(19) United States
(12) Patent Application Publication
(10) Pub. No.: US 2026/0148295 A1
(43) Pub. Date: May 28, 2026

(54) AI GENERATOR FOR LENDING SCENARIO INQUIRIES

(71) Applicant: InsydeAI, LLC, Linthicum, MD (US)

(72) Inventors: Christos Bettios, McLean, VA (US); Kamal RANABHAT, Parkville, MD (US)

(73) Assignee: InsydeAI, LLC, Linthicum, MD (US)

(21) Appl. No.: 19/396,623

(22) Filed: Nov. 21, 2025

Related U.S. Application Data
(60) Provisional application No. 63/723,764, filed on Nov. 22, 2024.

(51) Int. Cl. G06Q 40/03

(52) U.S. Cl. CPC G06Q 40/03055

(57) ABSTRACT

A system for producing Artificial Intelligence (AI) Large Language Model (LLM) generative pre-trained transformer (GPT) responses for loan generation questions and inquiries based on proprietary, non-public information is described. The system ma comprising one or more e processors and one or more non-transitory computer-readable storage media, the non-transitory computer-readable storage media.

### CROSS REFERENCE TO RELATED APPLICATION

This application is a Non-Provisional of U.S. Provisional Application No. 63/723,764, filed Nov. 22, 2024, the entire contents of which are incorporated herein by reference.

### BACKGROUND

In the course of business, lending companies often need to produce a variety of documents for their clients to review. In many instances, there may be standard features and documents associated with conventional loans, each individual loan scenario, however, requires specific information and entries that are unique to the client and the loan scenario. Thus, one is faced either with a plurality of “standard” documents that have may blank entries to be filled for each new scenario or the prospect of generating documents more or less from scratch or from a template. With the ready availability of open source GPT models, lenders can benefit by having their own proprietary GPT systems using internal sources, thus enabling them to perform electronic transactions securely without the ability of unauthorized users to see any of the details of the transaction.

Disclosed are embodiments for systems that produce Artificial Intelligence (AI) Large Language Model (LLM) GPT responses for a loan generation questions and inquiries based on proprietary, non-public information.

Example GPT systems are described in U.S. Pat. No. 11,748,555 and U.S. Patent Application Publication. 2023008067, the descriptions of which are incorporated herein by reference.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a system diagram illustrating an example system in which one or more disclosed embodiments may be implemented;

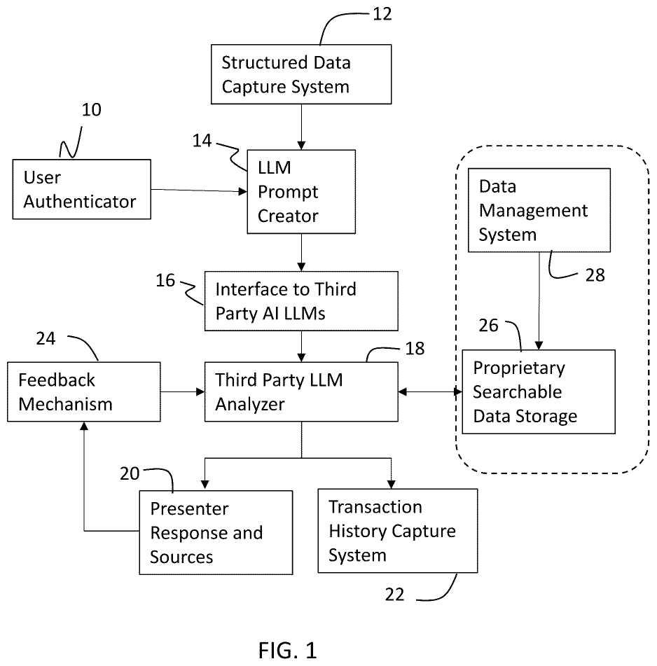

FIG. 2 is an example interface screen, according to embodiments described herein; and

FIG. 3 is a diagram of an exemplary device.

### DETAILED DESCRIPTION

The exemplary embodiments consist of major and subsidiary components implemented through a variety of separate and related computer systems. These components may be used either individually or in variety of combinations. It is noted that the invention is not limited to the specific embodiments described herein. Such embodiments are presented herein for illustrative purposes only. Additional embodiments will be apparent to persons skilled in the relevant art(s) based on the teachings contained herein. The section headings used herein are for organizational purposes only and are not to be construed as limiting the subject matter described

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

In embodiments, system is disclosed that produces an Artificial Intelligence (AI) Large Language Model (LLM) GPT response for specific loan questions and inquiries based on proprietary, non-public information.

In embodiments, the system design may include: a user authentication apparatus 10 to access a proprietary AI Generator; a structured data capture system 12, which may be implemented in a software program that collects data for the question and specific scenario. An LLM Prompt Creator 14, which may be implemented in a software program, that reviews inputs provided by the user authentication apparatus 10 and dynamically creates an optimized prompt/search request for information from an AI-formatted set of proprietary content. An interface program 16 that connects the LLM prompt creator to third party GPT systems 18.

Enterprise owned content may be processed by data management system 28 and may also include a proprietary data searchable data storage 26 The data management system may allow the user to store and segment proprietary information in a structure to support different scenarios, inquiries, and questions. A program that allows the user enterprise to publish and manage proprietary information, may be included in the data management system 28.

A presentation system that presents the responses in different electronic methods including website, email, sound, video, SMS may receive output from the third party LLM analyzer 18.

The system may further include in embodiments, a transaction history capture system 22 that retains the history of requests and responses.

The system may further include in embodiments a feedback mechanism 24 that captures user feedback and send that feedback to the third party LLM analyzer 18 to improve future results.

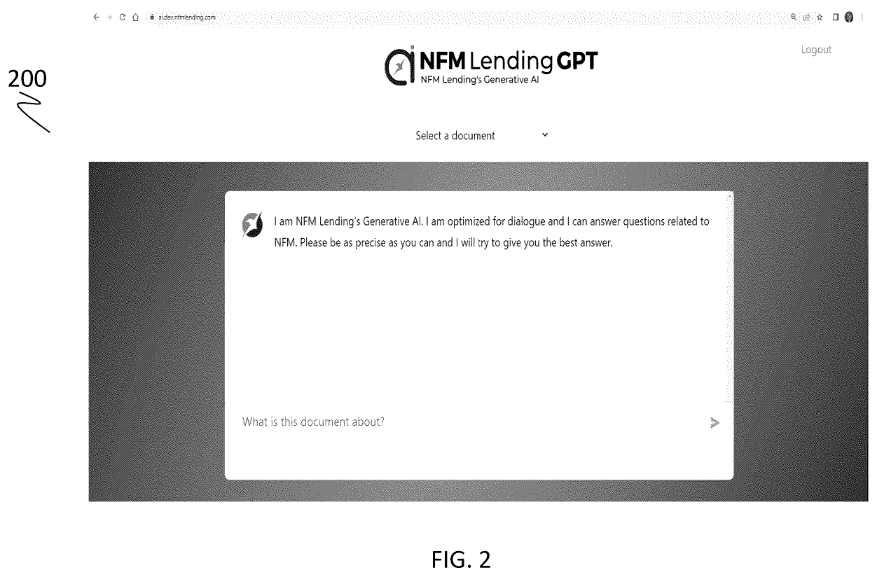

FIG. 2 is an example interface screen 200 that presents a dialog to a user. In embodiments, a user may be a loan officer, a real estate agent, a loan applicant or any other person or entity engaged in a loan process.

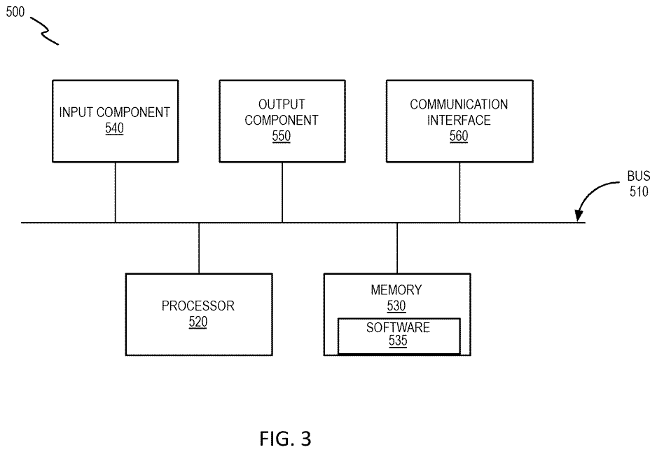

FIG. 3 is a diagram illustrating exemplary physical components of a device 500. Device 500 may correspond to various devices within the above-described system. Device 500 may be use in individual instances of the components described above. In further embodiments, more than one of the components described above may be implemented by device 500 or its equivalent. In embodiments, device 500 may include a bus 510, a processor 520, a memory 530, an input component 540, an output component 550, and a communication interface 560.

Bus 1310 may include a path that permits communication among the components of device 500. Processor 520 may include a processor, a microprocessor, or processing logic that may interpret and execute instructions. Memory 530 may include any type of dynamic storage device that may store information and instructions, for execution by processor 520, and/or any type of non-volatile storage device that may store information for use by processor 520.

Software 535 includes an application or a program that provides a function and/or a process. Software 535 is also intended to include firmware, middleware, microcode, hardware description language (HDL), and/or other form of instruction. By way of example, with respect to the network elements that include logic to provide proof of work authentication, these network elements may be implemented to include software 535.

Input component 540 may include a mechanism that permits a user to input information to device 500, such as a keyboard, a keypad, a button, a switch, etc. Output component 550 may include a mechanism that outputs information to the user, such as a display, a speaker, one or more light emitting diodes (LEDs), etc.

Communication interface 560 may include a transceiver that enables device 500 to communicate with other devices and/or systems via wireless communications, wired communications, or a combination of wireless and wired communications. For example, communication interface 560 may include mechanisms for communicating with another device or system via a network. Communication interface 560 may include an antenna assembly for transmission and/or reception of RF signals. In one implementation, for example, communication interface 560 may communicate with a network and/or devices connected to a network. Alternatively, or additionally, communication interface 560 may be a logical component that includes input and output ports, input and output systems, and/or other input and output components that facilitate the transmission of data to other devices.

Device 500 may perform certain operations in response to processor 520 executing software instructions (e.g., software 535) contained in a computer-readable medium, such as memory 530. A computer-readable medium may be defined as a non-transitory memory device. A non-transitory memory device may include memory space within a single physical memory device or spread across multiple physical memory devices. The software instructions may be read into memory 530 from another computer-readable medium or from another device. The software instructions contained in memory 530 may cause processor 520 to perform processes described herein. Implementations described herein are not limited to any specific combination of hardware circuitry and software.

Device 500 may include fewer components, additional components, different components, and/or differently arranged components than those illustrated in FIG. 2. As an example, in some implementations, a display may not be included in device 500. In these situations, device 500 may be a “headless” device that does not include input component 540. Additionally, or alternatively, one or more components of device 500 may perform one or more tasks described as being performed by one or more other components of device 500.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed:

1. A system for producing Artificial Intelligence (AI) Large Language Model (LLM) GPT responses for loan generation questions and inquiries based on proprietary, non-public information, comprising:
a user authentication apparatus configured to access a proprietary AI Generator;
a structured data capture system;
an LLM prompt creator;
an interface program configured to connect the LLM prompt creator to a third party GPT system;
a data management system comprising a proprietary data searchable data storage;
a presentation apparatus;
a transaction history capture apparatus and
a feedback apparatus.

2. The system of claim 1, wherein the presentation apparatus is configured to present information in least one of a website, an email, a sound, a video, or an SMS message.

3. The system of claim 1, wherein the transaction history capture apparatus is configured to retain a history of user requests and responses.

4. The system of claim 1, wherein the feedback mechanism is configured to capture user feedback and send the feedback to the third party GPT system.

5. A system for producing Artificial Intelligence (AI) Large Language Model (LLM) GPT responses for loan generation questions and inquiries based on proprietary, non-public information, comprising one or more processors and one or more non-transitory computer-readable storage media, the non-transitory computer-readable storage media having stored thereon at least:
a user authentication apparatus configured to access a proprietary AI Generator;
a structured data capture system;
an LLM prompt creator;
an interface program configured to connect the LLM prompt creator to a third party GPT system;
a data management system comprising a proprietary data searchable data storage;
a presentation apparatus;
a transaction history capture apparatus and
a feedback apparatus.

6. The system of claim 5, wherein the presentation apparatus is configured to present information in least one of a website, an email, a sound, a video, or an SMS message.

7. The system of claim 5, wherein the transaction history capture apparatus is configured to retain a history of user requests and responses.

8. The system of claim 6, wherein the feedback mechanism is configured to capture user feedback and send the feedback to the third party GPT system.
